(19) United States
(12) Patent Application Publication
(10) Pub. No.: US 2003/0053579 A1
(43) Pub. Date: Mar. 20, 2003

(54) DEUTERIUM HEAT GENERATOR

(76) Inventors: JOSEPH L. WAISMAN, IRVINE, CA (US); RICHARD H SUMMERL, SANTA ANA, CA (US)

Correspondence Address: FRANK CHARLES PRICE, 13812 SANDHURST PLACE, SANTA ANA, CA, 92705, US

(21) Appl. No.: 09/887,693

(22) Filed: Sep. 18, 2001

Related U.S. Application Data
(63) Continuation-in-part of application No. 09/348,142, filed on Jul. 2, 1999, now abandoned.
Application No. 09/348,142 is a continuation-in-part of application No. 08/917,147, filed on Aug. 25, 1997, now abandoned.

(51) Int. Cl. G21J 1/00

(52) U.S. Cl. 376/100

(57) ABSTRACT

This invention is a reactor and system with a method for containing and controlling a deuterium nuclear fusion reaction in a palladium host metal lattice, now generally referred to as ‘solid state fusion’. The reactor is designed for high temperature operation at moderate deuterium gas pressures and is operable over a temperature range of 400° C. to more than 1400° C. The solid state fusion reaction is enabled and controlled by providing specific combinations of reactor temperatures and deuterium gas pressures. The invention is capable of generating heat densities that are suitable for commercial applications. The highest heat densities are produced at higher temperatures and moderate pressures where the system is most efficient and cost effective.

### CROSS REFERENCES

Disclosures filed by the inventors at the Patent & Trademark Office, Washington D.C:

1. Disclosure Document Number 381513 dated Aug. 31, 1995.

2. Disclosure Document Number 401865 dated Jun. 28, 1996.

Other references:

4. “The Pathway to Commercial Applications”, by J. L. Waisman and R. H. Summerl, the Proceedings of the Seventh International Conference on Cold Fusion, held in Vancouver, British Columbia, Canada, Apr. 19-24, 1998, p 414.

5. Technical Note TN-7.1 “The Thermodynamic State of a Gas/Solid System” issued by J. L. Waisman & R. H. Summerl, revised Sep. 20, 1999.

6. “The Emergence of a Coherent Explanation for Anomalies Observed in D/Pd and H/Pd Systems: Evidence of ⁴He and ³He” by Michael McKubre, et al, ICCF-8, March 2000.

### BACKGROUND OF THE INVENTION

In the 1980's, Fleischmann and Pons (F&P) discovered that excess heat was produced when electrolyzing heavy water using a palladium (Pd) cathode. Their 1989 announcement brought on a rash of hurried experiments by the technical community to try to replicate the effect that had become known as “cold nuclear fusion”. Most such experiments failed; some for good cause. F&P sometimes had trouble replicating their own work. Nuclear physicists denounced the cold fusion effect because they believed that: (1) the same radiation products of deuterium fusion that had been experienced in ‘hot fusion’ should have been detected and (2) the Coulomb repulsion forces could be overcome only when temperatures in the 100,000,000° C. range are produced. Cold fusion was branded as an incredible hoax and virtually all funding in the United States was halted.

Throughout the 1990's, a number of dedicated scientists in laboratories around the world continued the research. More and more were successful in producing excess heat by electrolysis and some succeeded in measuring the helium products of the reaction. The heat generation densities were low and the helium measured was very small and did not show a consistent relationship with the timing and rate of heat production. In all cases, investigators were pursuing the highest possible concentrations of deuterium in the palladium lattice as the enabling process; the highest concentrations being achieved at lower temperatures.

Some groups tried to achieve high D/Pd concentrations by gas loading but were unable to reach the ultra-high gas pressures to equal the high equivalent pressures achieved by electrolysis.

Other groups gave gas loading their best effort hoping to measure energized particle radiation from the deuterized palladium and other hydrogen absorbing metals. Again their efforts were spent in trying to achieve very high D/Pd concentrations. Such experiments all failed for not recognizing that high temperature is a key ingredient for enabling a fusion reaction by gas loading.

More recently, four successful experiments which produced excess heat and showed the helium byproducts, that had been performed in four different laboratories, were carefully replicated at SRI, Int. (See Reference 6.) This replication work removes doubt about the reality of cold nuclear fusion which is now becoming known as ‘solid state fusion’.

But for one notable exception, all of the reaction rates were very low and of little practical use. In their very early work, F&P actually produced high density heat, accidentally at first and later in controlled experiments. This was their “boil dry” work which they reported as “ignition” in the accidental case and “heat after death” in their controlled boil dry experiments where the heavy water electrolyte was allowed to boil away and the palladium cathodes became very hot for a long period of time. The data from this boil dry work is shown on a plot of power density vs temperature in FIG. 9 to illustrate the significant effect of temperature in the production of high density heat.

It was this experimental work and other electrolytic work conducted at somewhat elevated temperatures that captured the attention of the present inventors who realized that the reaction rate was very much a function of temperature. The higher heat densities at higher temperatures could easily be correlated to thermodynamic principles but could not be correlated to higher D/Pd concentrations. High D/Pd concentrations at elevated temperatures cannot be achieved as noted on the equilibrium diagram for the deuterium-palladium system in FIG. 8.

The present inventors focused on the application of thermodynamic principles that would cause one to look, at an elevated system-free-energy state, for a ‘change of state’ of the deuterium within the confines of the metal lattice and that would enable the fusion reaction; a change that nullifies the Coulomb repulsion forces and makes a nuclear process possible. While this is a ‘macro’ point of view, it is now born out by very credible ‘micro’ theories currently being developed by solid state physicists.

The present inventors also focused on the necessary requirements for there to be commercial applications. For the cost of power production by this new method of heat generation in palladium to be competitive with heat produced using fossil fuels, it is necessary that it produce high density heat without the continuous input of power as is required by the electrolytic methods. The present invention will produce heat densities that are suitable for commercial applications at high temperatures without the continuous use of power.

### SUMMARY OF THE INVENTION

The present invention is a reactor and system with a method for containing and controlling a deuterium nuclear fusion reaction in a host metal lattice, such as palladium, now generally referred to as ‘solid state fusion’. The reactor is designed for high temperature operation at moderate deuterium gas pressures and is operable over a temperature range of 400° C. to more than 1400° C. Temperatures up to 3000° C. are achievable for host metals with high melting temperatures.

The solid state fusion reaction is enabled and controlled by providing specific combinations of reactor temperatures and deuterium gas pressures in the host metal's surroundings. Free energy thermodynamic principles are applied to determine the specific combination of temperatures and pressures for enabling and controlling the fusion reaction. They involve providing a high system free energy state, corresponding to a high deuterium-chemical-potential, that is above the threshold for a ‘change of state’ of the dissolved deuterium where it can and will achieve a new lower free energy. It is this ‘change of state’ that nullifies the Coulomb repulsion forces and permits fusion to occur. (See the definition of chemical potential given later.)

The deuterium, D, chemical potential is controlled by controlling the D gas pressure, P, and the reactor temperature, T. It must be remembered that for every value of D chemical potential, there is a specific associated family of temperature and D gas pressure combinations that will produce that same chemical potential value as is seen in FIG. 7 The fusion reaction is accelerated by increasing the operating D chemical potential, above the threshold.

To provide metals capable of hosting the reaction, a selection process of testing candidate host metals in a ‘scanning reactor’ is used to determine reaction thresholds and heat rates. The measured threshold chemical potential establishes the minimum operating conditions, temperature and pressure combinations, for the onset of heat production for a particular host metal and form. The measured heat production rates provide the temperature and pressure combinations necessary to achieve a desired heat production rate.

A means for stabalizing the temperature of the reaction by controlling the heat transfer rate is provided in the heat transfer system.

The reactor may be permanently sealed after ‘loading’ the deuterium, allowing the reactor to be stored and later operated separate from its deuterium pressurizing equipment. Use on a moving vehicle that requires portability of its energy source would be a typical candidate application for the sealed reactor. An inert filler material in the void space of the sealed reactor may be used to reduce the gas volume inside the reactor thereby amplifying the pressure increase achieved with increasing temperatures. For the amplification to be large, the void space volume must be reduced to be on the same order as that of the palladium. The life of a sealed reactor is limited due to the depletion of deuterium as helium is formed.

The heat-producing reaction is self-sustaining once enabled.

### BRIEF DESCRIPTION OF THE DRAWINGS

FIG. 1 is a longitudinal cross-section of a typical reactor showing the general arrangement of the host metal inside of the pressure vessel and the enabling heater (coil) on the outside surrounded by the heat transfer surface. The configuration shown in FIG. 1 is typical for heat transfer by radiation where the outer surface has a high emissivity. The enabling heater may be integrated into the heat transfer system if desired, rather than in the heat transfer surface, as is illustrated in FIG. 4 and in the schematic in FIG. 5. FIG. 1 also shows the location of the permanent seal when used, the inert filler material when used, and the thermocouple when used.

FIG. 2 shows the same typical reactor except with fins integrated into the heat transfer surface for heat transfer by convection.

FIG. 3 is a transverse cross-section of the reactor.

FIG. 4 is an alternate arrangement where the host metal is located in a position other than on the inside surface of the outer wall of the pressure vessel. Here the enabling heat is provided by externally heating the heat transfer fluid during start-up.

FIG. 5 is a typical schematic of the reactor and its operating system when the heat transfer method is by forced convection. Alternate control systems may be employed to suit the application requirements.

FIG. 6 shows a general arrangement of the scanning reactor, the temperature probe and a typical test sample.

FIG. 7 is a plot of the ‘System Free Energy State’ versus ‘Operating Temperature’ showing the range of operating chemical potentials, and the associated temperatures and pressures, over which the present invention is operable. An extended range is also noted.

FIG. 8 is the Deuterium-Palladium TCP Equilibrium Diagram.

FIG. 9 is a plot of selected experimental data showing where high density heat was produced at high temperatures.

### DETAILED DESCRIPTION OF THE INVENTION

The Reactor Assembly

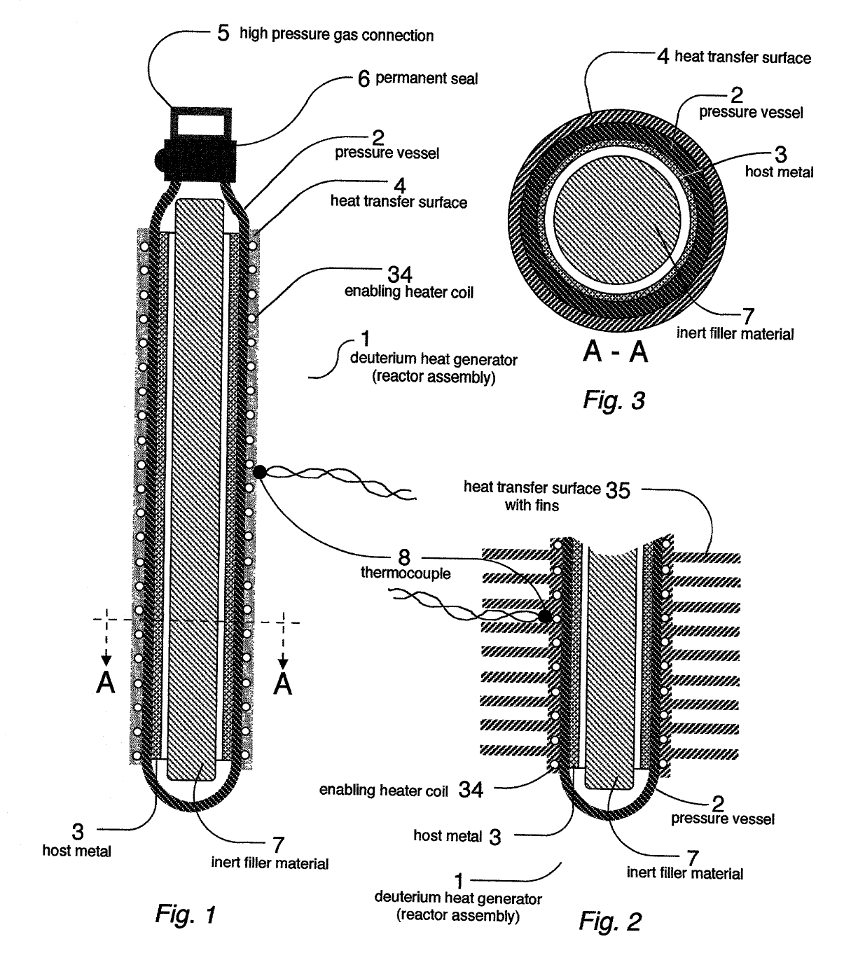

Referring to the FIGS. 1, 2 and 3 the deuterium heat generator 1, is hereafter called the ‘reactor’ or the ‘reactor assembly’. The reactor assembly 1 consists of: the pressure vessel 2; the host metal 3; the enabling heater 34; the heat transfer surfaces 4; a high pressure gas connector 5 to facilitate connection to the D gas pressure manifold 13; a permanent sealing device 6 when used; an inert filler material 7 when used; and a thermocouple 8 when used to determine the host metal temperature. The heat transfer surfaces 4: may be plain; may have fins 35 for heat transfer by convection; or may have a high emissivity coating for heat transfer by radiation. Heat transfer by a combination of convection and radiation may also be employed when that best suits the requirements of the application.

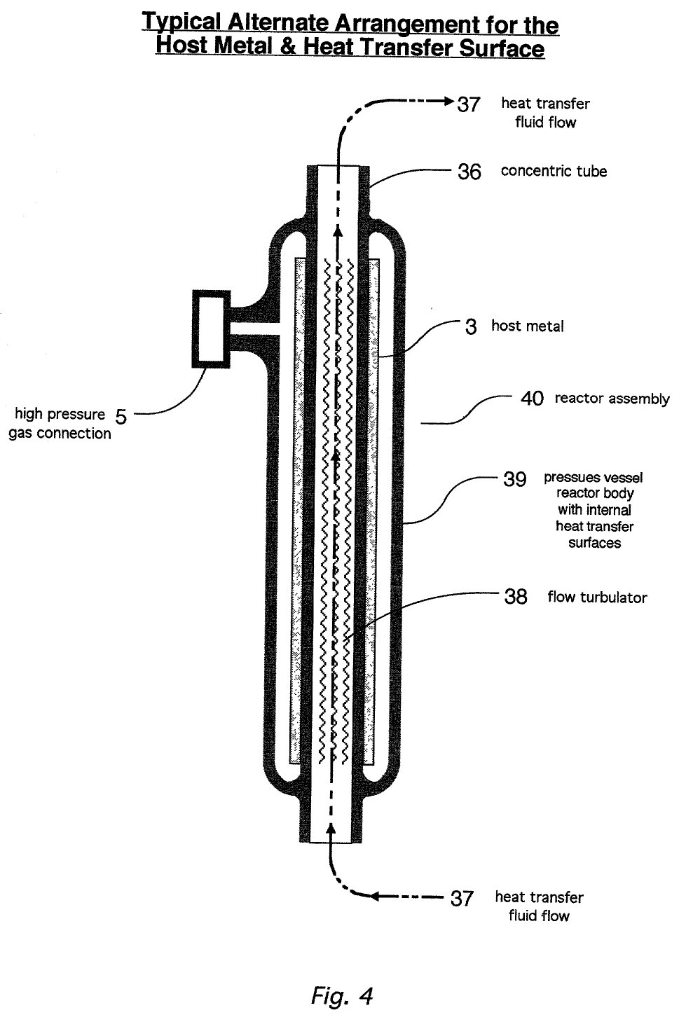

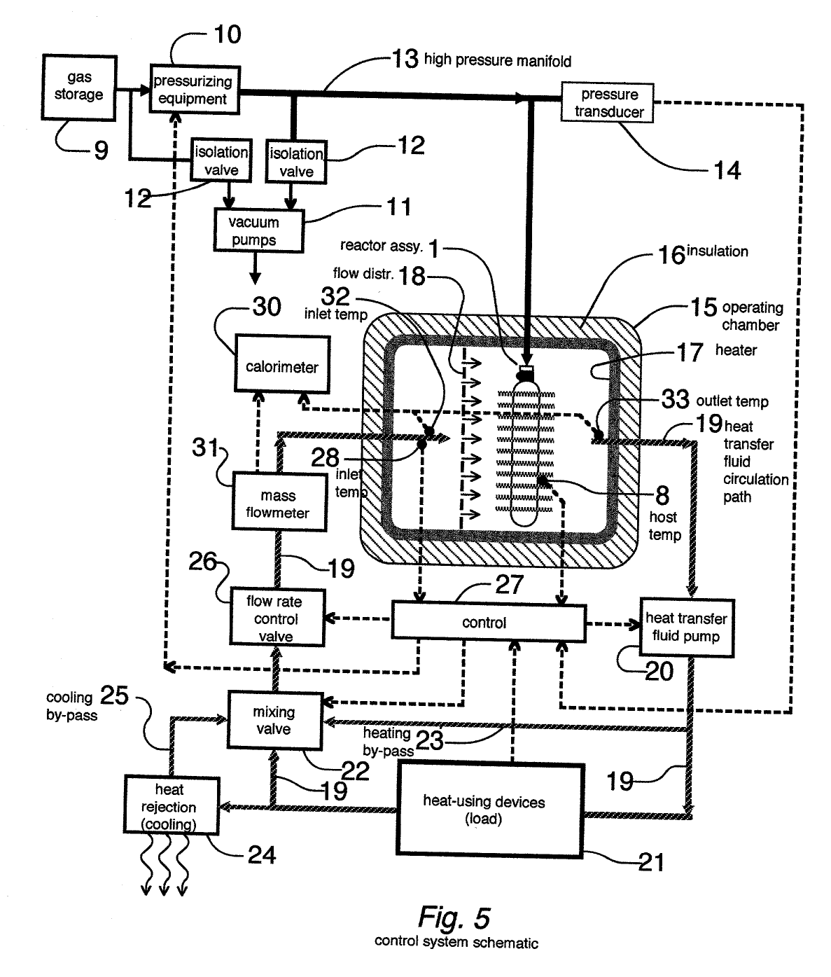

The reactor assembly 40 in FIG. 4 illustrates how the host metal 3 may be located in an alternate location in the pressure vessel. In this instance, the control schematic (not shown) would embody the same principles that are embodied in the schematic shown in FIG. 5.

When the reactor is to be permanently sealed, the opening to the reactor assembly must include a suitable device 6 and method for sealing at its predetermined ‘loading’ temperature and pressure. Such a device is one that provides a slightly tapered hole in a thick walled, restricted section of the filler neck that is transverse to the gas filling path and intersects it. An extrudable material is held in the transverse tapered section to provide the ‘working’ seal. When the permanent seal is to be made, the transversely held material is extruded into the filling path using a side force. Both the side and end openings may then be electron beam welded to form the long term permanent seal. Once the reactor is sealed, it must be stored at a suitable temperature that is well below the threshold temperature to ensure that the fusion reaction is not accidentally enabled. (See the later section on How the reactor works.)

The Reactor Body

In the preferred embodiment, the reactor pressure vessel body is made from a suitable high-strength, high-temperature metal or alloy which has one or more of the following properties: (1) impervious to hydrogen, (2) is not subject to hydrogen embrittlement and/or (3) is coated on the inside with a material such as beryllium-bronze which is impervious to hydrogen and its isotopes. The optimum diameter of the reactor pressure vessel and the thickness of the material used to form the pressure vessel body are determined by stress and strength analysis to suit the operating conditions.

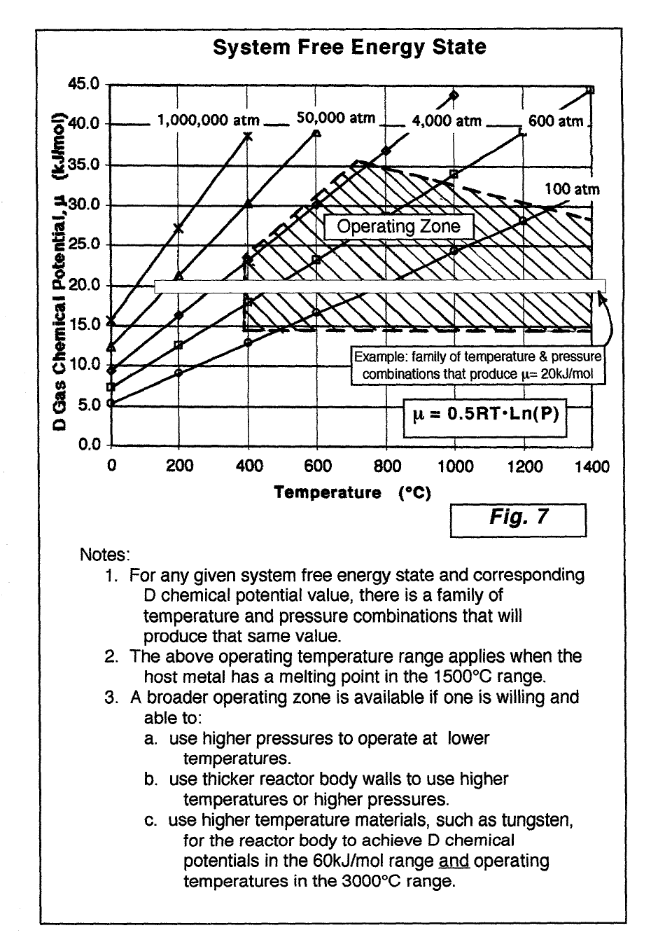

Generally, it is the application requirements that will set the design operating temperature; the materials and dimensions for the reactor body must be appropriately selected. In FIG. 7, the operable temperature range is from 400° C. to more than 1400° C.

In the lower to mid-range operating temperatures of 400° C. to 1000° C., materials for the pressure vessel body may be selected from a group of alloys used in the manufacture of jet engine turbine blades and in other high temperature uses. One such material is Carpenter's Pyromet Alloy 680 which is ideal for the 400° C. to 1000° C. range and is inexpensive and easy to machine.

For the higher temperatures in the 1000° C. to 1400° C. range, a material such as pure tungsten may be used. The operating range shown in FIG. 7 is applicable when the host metal is a metal such as palladium with a melting temperature in the 1500° C. range.

When using tungsten for the reactor body, the operating range of temperatures noted in FIG. 7 may be extended up to 3000° C. for use with a host metal having a high melting temperature. Also, when using tungsten for the reactor body, the range of operating deuterium chemical potentials may be extended into the 60 kJ/mol range.

The Host Metal

In the preferred embodiment, palladium is the host metal. Other candidate host metals may be selected from a group consisting of: titanium, zirconium, vanadium, thorium, lanthanum, praseodymium, tantalum, uranium, hafnium, nickel and cerium. The host material may also be an alloy, or mixture, of the selected metal with one or more other elements. Candidate host metal forms include wire, plate, foil, powdered and deposited forms. The final selection of the host metals is described in a later section, Host Metal Selection. The installation of the host metal is described in a later section, Host Metal Installation.

The Reactant Gas

In the preferred embodiment, the reactant gas is deuterium, D₂.

How the Reactor Works

The objective of the method described in this section is to enable and accelerate the heat producing reaction for the purpose of producing high density heat. Using the reactor and system in this Specification and following this method will create and exceed the system free energy states indicated by the experimental evidence presented in FIG. 9.

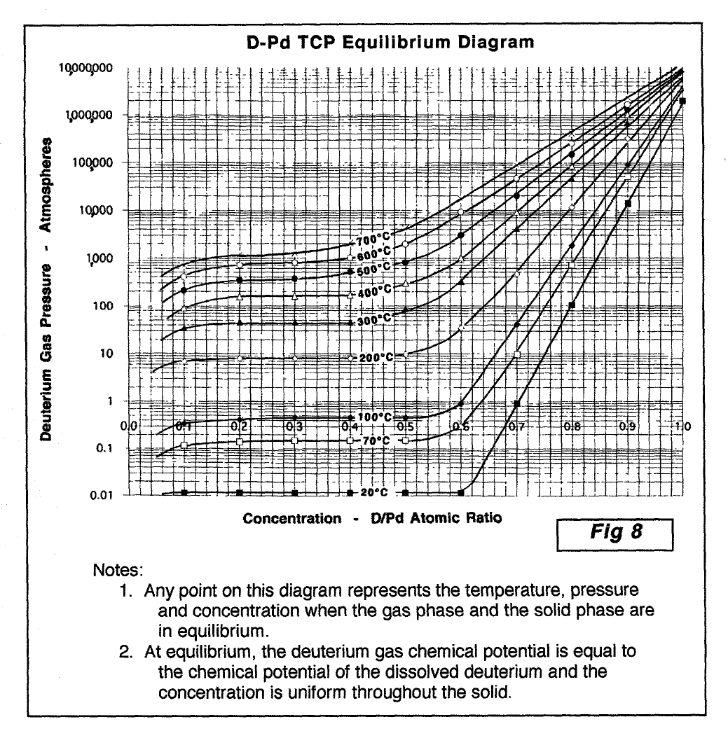

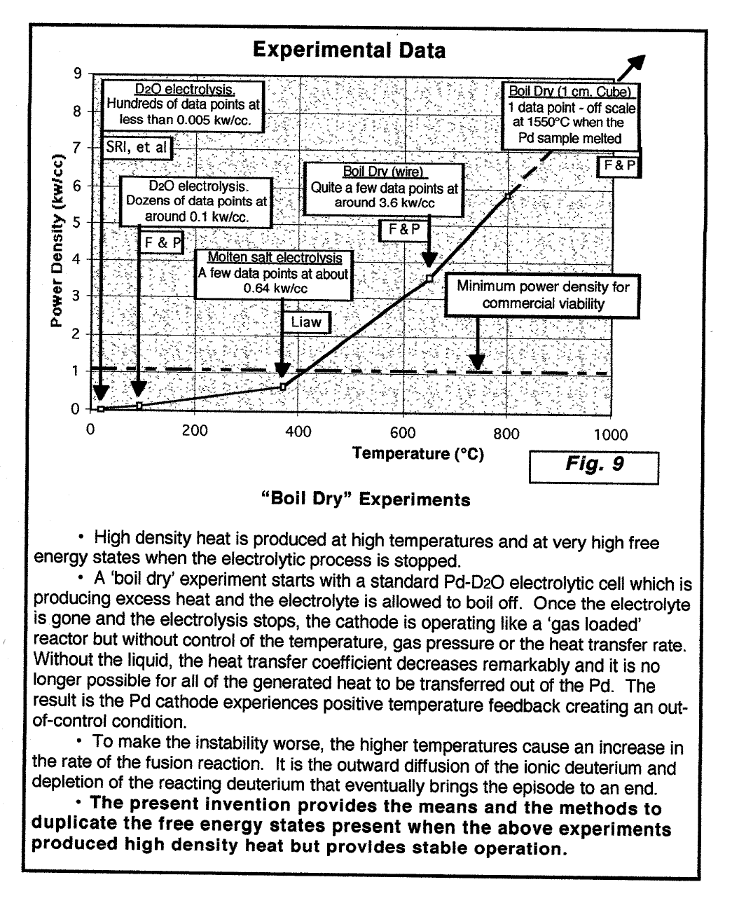

The deuterium is dissolved in the host metal by virtue of its being in contact with the surface of the palladium. The concentration of deuterium in the palladium is given by the D-Pd TCP Equilibrium Diagram as shown in FIG. 8.

At the high temperatures where the system is operative and high density heat is being produced, FIG. 9, the D/Pd concentrations will be low as indicated on the Equilibrium Diagram. There is no finite minimum D/Pd concentration required for operation; only that some deuterium be present.

The heat producing reaction is enabled by raising the system free energy state, corresponding to the deuterium gas chemical potential, to its reactive threshold level. At the threshold level, the ‘dissolved’ deuterium undergoes a change of state, seeking its lowest possible free energy. It is this change of state that nullifies the Coulomb repulsion forces and enables the fusion reaction. The chemical potential of the ‘dissolved’ deuterium, at equilibrium, is uniform throughout the host metal and it is a function of the deuterium ‘gas’ chemical potential at the surface of the host metal. The ‘gas’ chemical potential can be measured and controlled by controlling the D gas pressure and the reactor temperature. The threshold of the heat producing reaction is the deuterium ‘gas’ chemical potential that produces the ‘dissolved’ deuterium chemical potential that is critical to its change of state. The relationship between the gas chemical potential and the chemical potential of the dissolved deuterium is explained in Technical Note TN-7.1, Reference 5, and is shown explicitly in equations (h), (i) and (j) of that reference. The heat-producing reaction is spontaneous once it is enabled. The rate of the heat production is increased as the operating chemical potential is raised above the threshold.

For the sealed reactor, only the temperature can be controlled directly and the pressure for any given temperature is a function of that temperature. The pressure and the associated D chemical potential may be predicted for any given temperature knowing the ratio of the ‘free-gas-volume’ to the ‘palladium volume’ installed in the reactor as described in the later section, Predicting the performance of sealed reactors.

Chemical Potential

In the present invention, the term ‘D chemical potential’ is used as a measure of the free energy state of the system. The term ‘chemical potential’, when used for a gas-metal system, is defined as the change in Gibbs Free Energy, in Joules per mol, that would be required to force one more mol of a gas into a large gas/metal system, at its present free energy state, while holding the temperature, pressure and the concentration of other species constant. The chemical potential, μ, of the deuterium gas is given by the equation:

μ=(0.5RT)Logₙ(P/P₀) (Equation 1)

where: μ is the gas chemical potential (J/mol), R is the gas constant (8.32 Joules/mol°K), T is the temperature in Kelvin, P is the deuterium gas pressure in atmospheres and P₀ is the selected standard state pressure of 1 atmosphere. Since the chemical potential of the dissolved deuterium is a function of the D gas chemical potential, it is also a function of the two control variables, T and P.

Host Metal Selection

The threshold deuterium gas chemical potential may vary from one candidate host material lot to another. The threshold D chemical potential for a specific host metal is also dependent on the system's electronic Fermi energy as well as other factors including the purity, crystal size and regularity, and the population of flaws, cracks, vacancies, distortions and dislocations in the crystal lattice structure of a particular host material. Some of these micro-properties might be altered in the process of installing the host inside of the reactor.

Because of this variation in micro-properties, each lot of the candidate metals is subjected to screening tests, in their final form, to determine their threshold deuterium gas chemical potentials. Such screening tests are conducted for any candidate host metal in a properly instrumented pressure vessel. The material-form combinations with the lowest threshold chemical potentials are the best candidates. The final selection of a metal/form will be dictated by the application requirements.

The ‘instrumented’ pressure vessel for screening the candidate host materials is called a ‘scanning’ reactor with means for temperature and deuterium gas pressure control. For the scanning reactor to be an effective tool for the process of selecting the host metal and form, it is designed for a broad operating range in terms of high D chemical potentials, high temperatures and high pressures. When the reactor body is made from pure tungsten, D chemical potentials up to the range of kJ/mol70, operating temperatures up to about 3000° C. and D gas pressures up to the range of 4000 atmospheres can be achieved.

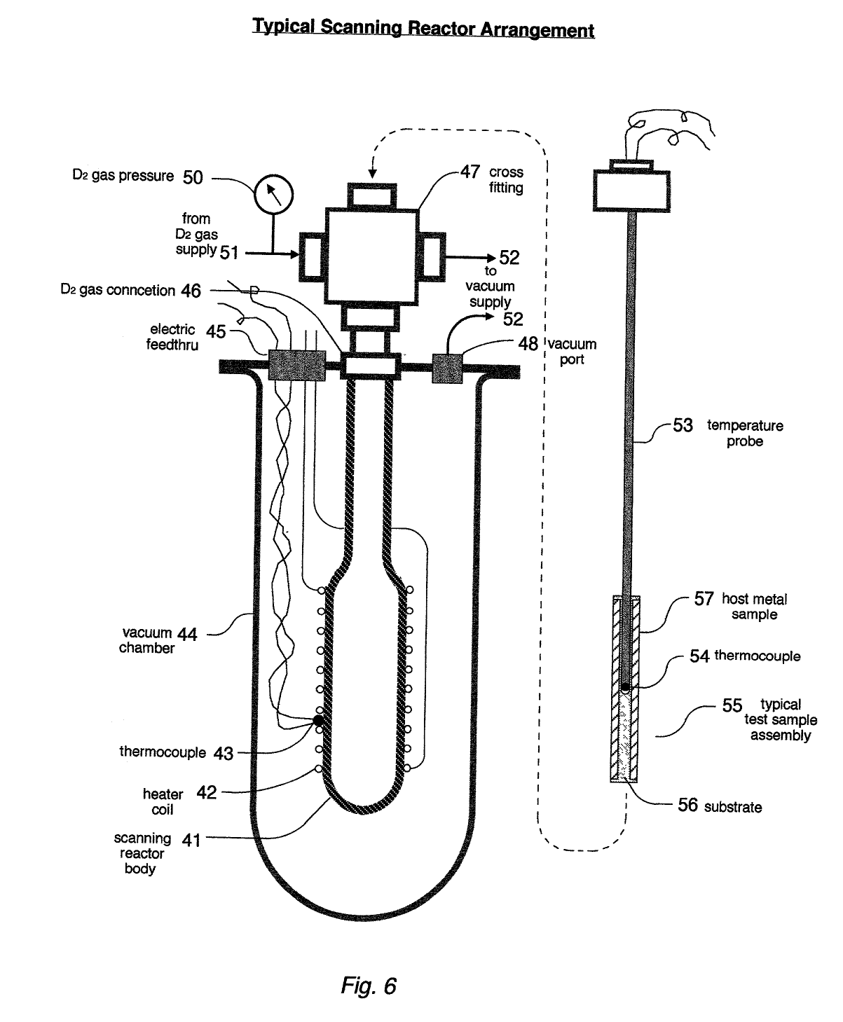

A typical general arrangement of the scanning reactor and typical test samples are shown in FIG. 6.

The scanning reactor body 41 is designed to minimize heat conduction to its attachment base and to minimize heat radiation to its surroundings. By operating in the vacuum provided by the vacuum chamber 44, the losses by convection are eliminated. The sensitivity of threshold measurements and the accuracy of heat rate measurements depend on how well the reactor is isolated. The material for fabrication of the reactor body 41 should be selected from the group of candidates for the production reactor noted in the previous section, The reactor body.

The heater coil 42 is the means to control the temperature of the test sample.

The base of the vacuum chamber 44 incorporates the D₂ gas pipe connections 46 for the scanning reactor and the external piping. The base also incorporates the electric wire feed-thru 45 and the vacuum port 48.

The cross fitting 47 permits ready through access to the reactor body for the test sample assembly 55 facilitating rapid change of test samples with just a single high pressure disconnect. It 47 also provides side ports for the high pressure D₂ gas from the gas supply system 51 and access to the vacuum system 52. The D₂ gas pressure gage 50 provides the necessary pressure data for calculating chemical potentials.

The test sample assembly 55 consists of a substrate 56 and the host metal sample 57. The host metal sample 57 is processed onto the substrate using the installation process planned for the production reactor.

The thermocouple 43 is the reference measurement for detection of the onset of fusion heating by the thermocouple 54 on the temperature probe 53. When the system is at thermal equilibrium and the fusion reaction is not yet enabled, the two thermocouples 43 and 54 will read alike. When the onset of the fusion reaction is reached, the thermocouple 54 on the probe will read higher than than the thermocouple 43 on the reactor body. The temperature rise (54 minus 43) due to the onset of ‘fusion’ heating is one that persists beyond the transient heats due to dissociation, ionization, solution and lattice transformation.

Measurement of the threshold D chemical potential is accomplished by recording the reactor body temperature 43 and gas pressure 50 at the onset of the heat producing reaction when a temperature rise 53 of the test sample above the surroundings is detected. The threshold chemical potential is then calculated from the Equation 1 noted above using that temperature 43 and pressure 50 recorded at the onset.

Once the threshold D chemical potential is measured for particular sample, there is a family of temperature and pressure combinations that will produce that same D chemical potential. These data are a part of the temperature and pressure conditions needed for reactor design.

The scanning reactor is also used to measure the heat production rates over the range of operating temperatures specified for the application. For the scanning reactor to be effective for measuring rates, it must also incorporate calorimetry. One direct measurement method is by noting the reduction of control heater 42 power to maintain constant temperature 43 when the test sample 57 is producing heat. For this method of calorimetry, all heat losses must be minimized. To make these rate measurements, the installed volume of the host metal sample 57 is adjusted so that the heat generated at the test operating conditions is approximately equal to the mid-range of heat produced by the heater 42. Knowing the heat necessary to make up the losses in the system at the test temperature, the heater power may be reduced from its ‘loss maintenance’ rate to compensate for the heat generated by the test sample, thereby maintaining a constant temperature and giving a direct reading of the heat generated.

Knowing the volume or weight of host metal in the test sample, the average power density may be readily calculated, in watts per cubic centimeter, for each level of operating chemical potential applied. It is this heat production rate characteristic of the host metal that will permit determination of the thickness of the host metal to be used for a particular application.

The scanning reactor is also used to determine the slope of the heat generation rate curve at the design operating temperature so that the heat transfer system may be designed for stability. The slope of the heat transfer characteristic curve at the operating conditions must be greater than the slope of the power production curve at that point for there to be a stable operating temperature. Determining the slope of the sample's characteristic heat production curve is accomplished by measuring the heat generation rate over a range of temperatures above and below the design operating temperature and plotting the data for analysis.

Host Metal Installation

In the preferred embodiment, the host metal is affixed to the inside surface of the reactor so that heat flow from the host metal to the heat transfer surfaces is enhanced. Other designs may place the host metal at other locations inside the reactor. This is illustrated in FIG. 4 where the heat transfer surface is along the central heat transfer fluid tube 36.

Candidate methods for installation of the host metal include: (1) various deposition processes, (2) other solid forms, which may be on a substrate, and (3) powdered forms sintered in place, or otherwise confined. Some candidate methods of installing the host metal are briefly described here:

(1) Fabricate the host metal in the form of a tube in the metal-producing mill by standard techniques of casting, and a series of “drawing” steps with intermediate anneals. This is a “bulk” technique. The dimensions of the host metal tube are such that the outside is a close fit to the inside of the reactor body. The outside surface of the host metal tube may be coated with brazing material. After insertion, a mandril may be inserted to expand the host tube to an “interference” fit. The assembly is then heated to the brazing temperature to produce a strong and conductive interface.

(2) Another method employs the use of host metal in a powdered form, available commercially, which is placed into position so the powder tightly fills a tubular space inside the pressure vessel, kept in place by a mandril. The assembly is then heated to the sintering temperature, which produces inter-diffusion of host metal powder particles so they become firmly attached to each other and to the inside surface of the reactor body. The mandrel is then removed.

(3) Still another method is to use a vapor-deposition technique in which a vapor of host metal is produced in an evacuated space and is deposited in a layer on the inside surface of the reactor body.

The host metal is cleaned after installation to remove surface contamination and facilitate the solution of deuterium.

The design thickness of the host metal will vary from a fraction of a millimeter to several millimeters depending upon the host material selected, its measured heat production rates over the operating temperature range and the required surface power density, or heat flux, specified for the application.

The present invention is operable with any one of many installation methods. In each case, the threshold D chemical potential and the power production characteristics are determined by ‘scanning’ tests for the specific combination of host metal and installation process to complete the design.

System Control

Heat production rate stability is preserved by maintaining a constant host metal temperature for a given deuterium gas pressure. This is accomplished by ensuring that the heat transfer rate away from the reactor is equal to the heat generation rate at the desired operating temperature. Since the reaction heat rate is an exponential function of temperature, positive temperature feedback and ‘run-away’ may occur if the heat transfer rate is inadequate.

When heat transfer is by forced convection, the host temperature, for a given deuterium gas pressure, is controlled by controlling the temperature and the flow rate of the heat transfer fluid as seen in FIG. 5.

When heat transfer is by radiation, with a high operating temperature for the reactor and a low receiver temperature, the heat transfer rate is essentially a fourth power function of absolute temperature of the reactor. In general, if the reactor's operating heat generating rate is less than a fourth power function of temperature, then the reactor will be stable at the design operating temperature. If the heat generation rate is greater than a fourth power function of absolute temperature, then supplemental convection or conduction cooling of the reactor may be required to maintain stability.

Control of the Sealed Reactor

Startup and control of the sealed reactor is accomplished by controlling only the temperature of the reactor.

The performance of a sealed reactor is determined the same way as that for a pressure controlled reactor; the fusion reaction is enabled by producing the threshold chemical potential measured for the host metal in the scanning reactor. The rate of the reaction is increased by increasing the operating D chemical potential over the threshold. The difference for the sealed reactor is that the internal D gas pressure cannot be changed independently or even measured easily. It can, however, be predicted and the D chemical potentials can then be calculated for any given temperature.

By predicting the internal pressures and calculating D chemical potentials over the operating temperature range, the threshold temperature and the heat generation rates of the reactor at various temperatures above the threshold can be calculated.

Predicting the Performance of Sealed Reactors

When the reactor is operating in the sealed condition, the internal reactor gas pressure, at any given temperature, is dependent on (1) the mass of the deuterium in the host metal and in the void volume at the time of sealing, and (2) the ratio of the ‘void-volume’ to the ‘host-metal-volume’ inside the reactor. The pressure then is a function of the reactor temperature and changes as the temperature changes.

To predict the pressure for any given temperature, it is necessary to first determine the total number of mols of deuterium that were ‘installed’ at the time of sealing. To determine the number of mols of deuterium in the host metal, the total number of mols of host metal installed inside the reactor must be known and the reactor temperature and gas pressure at the time of sealing must have been measured. The number of mols of dissolved deuterium within the host metal is then determined using concentration data from the TCP Equilibrium Diagram, FIG. 8. The number of mols of deuterium in the void volume, n, is calculated using the ideal gas law, PV=nRT. The sum of the two numbers is the total installed deuterium and it will remain the same at any other temperature once the reactor is sealed.

As temperature is increased, some of the dissolved deuterium in the metal will be driven into the void volume thereby amplifying the pressure increase that would have occurred had there been no change in the concentration of deuterium in the host metal. At the higher temperature and at the resulting higher pressure, a new equilibrium will be reached which will further increase the operating D chemical potential and hence the reaction rate. The pressure amplification factor is a function of the ratio of ‘void-volume’ to ‘host-metal-volume’. This ratio may be adjusted in design by adding an inert filler material to fill the void space.

When the void volume is large relative to the host-metal volume, the pressure amplification due to deuterium expulsion from the host metal with a rise in temperature is small. When an inert filler material is used to significantly reduce the void volume, the pressure amplification as a result of deuterium expulsion from the host metal may be made very large (in the range of 100 times and more) depending on how much the void volume is reduced by the filler. The preferred material for the inert filler material is one which is relatively impervious to hydrogen. The filler material may be a solid core or a closely packed loose material. Quartz or alumina are candidates for the filler material.

Useful Life of the Sealed Reactor

The useful life of the reactor, when operating sealed, is limited since deuterium is depleted in the reaction. As deuterium is converted to helium, the partial pressure of the deuterium in the void space will decrease and the partial pressure of the helium will increase. This decrease in the partial pressure of the deuterium will have the effect of reducing the operating D chemical potential and hence the rate of the fusion reaction.

When the application requires that the heat generation rate remain constant, then it will be necessary to compensate for the drop in pressure by operating the reactor at a correspondingly higher temperature to maintain the same operating D chemical potential. In convective heat transfer, this is accomplished by decreasing the heat transfer rate. This action will cause the temperature to rise and the correct operating D chemical potential to be restored. When the operating heat generation rate is restored at a higher temperature, then the heat transfer rate may require readjustment so that it is equal to the restored heat production rate.

In this case, the useful life of the sealed reactor is limited to how much adjustment in operating temperature can be made before the maximum temperature allowable for that particular reactor body design and material is reached.

When the application can tolerate a drop in the heat generation rate, then the useful life of the sealed reactor is limited to the time to reach the minimum heat generation rate that meets the minimum application requirements.

The Operating System

A given reactor operating system is designed to fit the application requirements in terms of the operating conditions and the method of heat transfer. As a minimum, the control system must incorporate: (1) a means to load the deuterium into the reactor and host metal, (2) a means of controlling the chemical potential of the dissolved deuterium, (3) a means of extracting all of the generated heat and thereby providing a means of controlling the temperature of the host metal.

Loading the Reactor

Referring to FIG. 5, the deuterium gas pressurization system consists of a gas storage system 9, pressurization pumps 10, vacuum pumps 11, isolation valves 12, a high pressure manifold 13 to interconnect the components and to connect the system to the reactor assembly 1. The pressure in the manifold is indicated by pressure gage 14 which may include an electronic pressure signal to the operating control panel 27. The gas storage system 9 may include filters, traps, regulators, etc.

The reactor 1, the manifold 13, the pressurizing equipment 10, the gas storage equipment 9 and associated lines are evacuated through the isolation valves 12 using the vacuum pumps 11 to remove contaminating gases. When the enabling heater 34 (in FIGS. 1 & 2) is not integrated into the heat transfer surfaces, then the operating chamber 15 heater 17 may be operated to raise the temperature of the reactor to a value in the 600 to 800° C. range for an extended period of time while under vacuum to remove residual contamination from the reactor and host metal.

Typical Loading Procedures

In the preferred loading method, the temperature of the reactor 1 and the operating chamber 15 is raised above 400° C. while still under vacuum using the enabling heater 34 (FIGS. 1 & 2) or heater 17 (FIG. 5). The heat transfer fluid pump 20 is off during the loading procedure. The isolation valves 12 are closed and the deuterium gas supply valve and regulator 9 are opened. The deuterium gas is pumped into the high pressure manifold 13 and reactor 1 using the pressurization equipment 10 controlled from the control panel 27 and is indicated on the manifold pressure gage 14. The gas pressure is raised to that value necessary, at the loading temperature 8, to achieve the threshold chemical potential for heat generation and the reactor 1 is ready for operation as a heat generator. When the threshold chemical potential cannot be reached at the selected loading temperature, then a higher loading temperature must be used. An alternative is to load at the lower temperature and then raise the temperature until the threshold is reached

When the reactor is to be used as a sealed reactor, it is loaded with deuterium to a predetermined temperature and pressure and then sealed. The final loading temperature and pressure at sealing are selected so that the deuterium gas pressure inside the reactor will reach the correct pressure at the design operating temperature to produce the required D chemical potential which, in turn, produces the desired heat generating rate.

After permanently sealing a reactor, it may be removed from the pressurization system and stored for later use as a heat generator. Controlled low temperature storage may be required to ensure that the threshold chemical potential is not accidentally reached.

System Operation

Referring to FIG. 5, the operating chamber 15 consists of: insulation 16 on the outside, a heater 17 on the inside (or other means of heating the reactor for start-up), a heat transfer fluid distribution system 18 which ensures that virtually all of the fluid impinges on the reactor's heat transfer surfaces, an inlet temperature thermocouple 28 for control of the fluid temperature as it begins circulation over the reactor surfaces. A calorimetry system 30 utilizes inlet and outlet thermocouples 32 & 33 and the heat transfer fluid mass flow meter 31 to determine the heat generation rate.

The heat transfer system utilizes a heat transfer fluid, circulating in lines 19, 23 and 25, which may be a gas or a liquid to suit the application, and consists of: the circulation pump 20, mixing valve 22 for controlling the temperature of the heat transfer fluid 28 at the inlet of the operating chamber 15, the cooling heat exchanger 24 and cooling line 25 which supplies cooler fluid to the mixing valve 22, a heating by-pass line 23 which provides hotter fluid to the mixing valve 22, flow rate control valve 26 to provide heat production stability control by ensuring that the heat transferred out is equal to the heat generated in the reactor, and the mass flow meter 31 which provides data required for calorimetry 30. The loads 21 and heat rejection devices 24 remove the generated heat. The flow rate control valve 26 may be eliminated if the pump 20 has a flow-rate control feature built into the pump.

Before operating the system, the operating chamber 15 and all of the heat transfer fluid components, including the heat-using devices 21, are purged of all unwanted fluids and the selected heat transfer fluid with a known specific heat is introduced.

Typical Operation at the Desired Power Production Rate

Once (1) the reactor 1 and the heat transfer system have been brought up to the design operating temperature range 8, (2) the deuterium gas pressure 14 has been increased so that the threshold of heat production has been surpassed and (3) the reactor heat generation rate exceeds the system loss rate, the heater 17 (or the enabling heater 34) may be turned off. The host metal temperature is now under control of the heat transfer system. It is controlled by adjusting (1) the mixing valve 22 position to provide heating 23 or cooling 24 & 25 of the heat transfer fluid after heat is extracted by the loads, and (2) the heat transfer fluid flow rate control valve 26.

The average power production rate is controlled by controlling the reactor temperature 8, as noted above, and the deuterium gas pressure 14 so that load demands 21 are met with the mixing valve 22 in approximately the center position. Short-term changes in load demand are met by adjustments in the heat transfer fluid temperature 28 and flow rate 26. Reactor stability control takes priority over load demand.

When the reactor is operating sealed, the heat generation rate is modulated by adjusting the operating temperature 8. As the deuterium is depleted, the power production rate for a given temperature will decrease. To compensate, the reactor is operated at gradually higher temperatures over the life of the reactor. This is accomplished by adjusting the flow rate control vale 26. A reduced flow will increase the operating temperature and an increased flow will reduce the operating temperature. After any adjustments in temperature, it is necessary to restore the heat transfer rate to be equal to the generation rate for stability.

With the reactor is operating unsealed, it, and its operating system will require periodic maintenance to remove the product of the reaction, helium. When the reactor is operating sealed, it will require periodic recycling to remove the products of the reaction.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A system for generating solid state deuterium fusion heat at elevated system free energy states, corresponding to high deuterium chemical potentials, comprising:
a pressure vessel reactor; said reactor having a void space; said void space containing a host metal and deuterium gas; said deuterium gas at elevated pressure within said reactor void space and dissolved in said host metal;
a means of providing a vacuum in said reactor before said deuterium is introduced;
means of controlling said reactor's temperature and said deuterium gas pressure;
means of transferring the generated heat to a useful load.

3. The system of in claim 1, comprising:
a means of permanently sealing said pressure vessel after introducing said deuterium.

4. The system of claim 3, comprising:
inert filler material inside said pressure vessel to reduce said void space; said reduction in void space enhancing the deuterium gas pressure increase as the reactor temperature is increased.

5. The system of claim 1, wherein said host metal is palladium.

6. The system of claim 1, wherein said host metal is titanium.

7. The system of claim 1, wherein said host metal is nickel.

8. The system of claim 1, wherein said host metal is zirconium.

9. The system of claim 1, wherein said host metal is vanadium.

10. The system of claim 1, wherein said host metal is thorium.

11. The system of claim 1, wherein said host metal is lanthanum.

12. The system of claim 1, wherein said host metal is praseodymium.

13. The system of claim 1, wherein said host metal is tantalum.

14. The system of claim 1, wherein said host metal is uranium.

15. The system of claim 1, wherein said host metal is hafnium.

16. The system of claim 1, wherein said host metal is cerium.

18. The system of claim 1, wherein said host metal is in a powdered form.

19. The system of claim 1, wherein said host metal is in a solid form.

20. Using the system of claim 1, comprising:
a method in which deuterium gas chemical potentials in the range of 15 kJ/mol to 50 kJ/mol are produced at temperatures ranging from 400° C. to 1500° C. and at deuterium gas pressures ranging from 25 atmospheres to 2,000 atmospheres.

21. Using the system of claim 3, comprising:
a method in which deuterium gas chemical potentials in the range of 15 kJ/mol to 50 kJ/mol are produced at temperatures ranging from 400° C. to 1500° C. and at deuterium gas pressures ranging from 25 atmospheres to 2,000 atmospheres.

22. A system for testing candidate host metals to determine their threshold deuterium gas chemical potentials and heat production rates comprising:
a pressure vessel reactor; said reactor for containing said candidate host metal and deuterium gas under pressure;
a heater surrounding said reactor;
a means of providing a vacuum in said reactor before said deuterium is introduced;
a system design that minimizes heat transfer away from said candidate host metal and heat transfer away from said reactor;
a probe for supporting said host metal in said reactor;
a temperature sensor in the end of said probe;
means of measuring said deuterium gas pressure and said reactor temperature;
means of controlling said reactor temperature and said deuterium gas pressure;
a means of measuring the heat generation rate within said host metal.

23. Using the system of claim 22, comprising:
a method in which said deuterium gas chemical potentials in the range of 15 kJ/mol to 75 kJ/mol are produced at temperatures ranging from 400° C. to 3000° C. and at deuterium gas pressures ranging from 5 atmospheres to 4000 atmospheres.

24. Using the system of claim 22, comprising:
a method in which the said threshold deuterium gas chemical potential at the onset of said heat generation is determined for said candidate host metal.

25. Using the system of claim 22, comprising:
a method in which said heat generation rates are determined for said candidate host metal.

26. Using the system of claim 1, comprising:
a method of said heat generation by providing said deuterium chemical potentials in excess of measured threshold deuterium chemical potentials for said host metal.

27. Using the system of claim 3, comprising:
a method of said heat generation by providing said deuterium chemical potentials in excess of measured threshold deuterium chemical potentials for said host metal.
